(19) United States
(12) Patent Application Publication
(10) Pub. No.: US 2007/0174781 A1
(43) Pub. Date: Jul. 26, 2007

(54) Parameter visualization

(75) Inventors: David H. Begin, Campbell, CA (US); Paul Major, San Jose, CA (US)

Correspondence Address: Raj Abhyanker, LLP;C/O PortfolioIP, P.O. Box 52050, Minneapolis, MN, 55402, US

(73) Assignee: Catalog Data Solutions

(21) Appl. No.: 11/338,928

(22) Filed: Jan. 25, 2006

(51) Int. Cl. G06F 3/048

(52) U.S. Cl. 715/780; 715/764

(57) ABSTRACT

A parameter visualization method and apparatus are disclosed. In one embodiment, a method includes processing a selection of a parameter based on an action associated with one parameter, algorithmically calculating compatibility of other parameters based on the selection, and simultaneously displaying at least one allowable parameter (e.g., of the other parameters) in a first visual state and displaying at least one excluded parameter (e.g., of the other parameters) in a second visual state. The parameter and the other parameters may be displayed in a graphical representation, and the graphical representation may be refreshed when another selection is processed based on an action (e.g., the action may a movement of a pointing device over the graphical representation of the parameter, a data input into an attribute field and/or a physical selection by the pointing device, etc.). The action may be associated with the at least one allowable parameter.

### FIELD OF TECHNOLOGY

This disclosure relates generally to the technical fields of software technology and, in one example embodiment, to a parameter visualization method and apparatus.

### BACKGROUND

Products and services are becoming increasingly complex. A buyer of a product (e.g., and/or a service) is often provided numerous and/or conflicting options associated with the product (e.g., and/or the service). For example, a car may be available in standard, sport, and luxury models. A cloth seating may only be available in the standard model and the luxury model, but when the cloth seating is selected, the buyer may not be able to select an onboard navigation system (e.g., because cars having the onboard navigation system may be manufactured only with a leather seating). In addition, only certain colors and/or options may be available for a car exterior and/or a car interior when the sport model is selected (e.g., red striped interior with lightweight frame exterior), and these options may not be available if the buyer selects the luxury model and/or the standard model.

Traditional product configurators are based on a hierarchical system (e.g., mirroring a bill of materials) in which the buyer selects a parameter from the highest available attribute, and then search results are narrowed to remaining options. For example, if the buyer selects the sport model of the car (e.g., a parameter in the highest available attribute), a choice for the cloth seating will not be displayed. Similarly, when the buyer selects the luxury model and/or the standard model, options for the certain colors and/or options available to the buyer had the buyer selected the sport model (e.g., red striped interior with lightweight frame exterior), may not be displayed to the buyer (e.g., may be invisible to the buyer on the product configurator website).

As such, the buyer may be uninformed of the effects of his previous selection(s) on the narrowing of the available options remaining, and/or may not be able to choose and/or prioritize preferences of various options (e.g., color, cloth type, onboard navigation system, etc.). For example, if the buyer really wanted to purchase the car with the cloth seating and the red striped interior, he would have to manually experiment with the product configurator by selecting different parameters in the highest available attribute (e.g., by selecting between different ones of the standard model, the sport model, and/or the luxury model) and manually discover the conflict by extrapolating that he must select the sport model to get the red striped interior and the standard model and/or the luxury model to purchase the cloth seating. In addition, the buyer may have to further experiment with the configurator to discover that he cannot purchase the onboard navigation system along with the cloth seating (e.g., by panning trough multiple layers of options and/or hierarchies). This manual experimentation can be a time consuming and/or confusing process, and many buyers may simply decide to postpone their purchase of the car.

In some product configurators, the buyer may enter a part number based on a well defined numbering scheme. For example, if the buyer wishes to bypass the configurator, the buyer may enter ‘CAR-LUX-LIGHTFRAME-CLOTH-NAV’ as the part number when placing an order (e.g. the buyer may wish to purchase the luxury model of the car having light weight frame exterior, the cloth seating, and the onboard navigation system). This part number may be invalid if the luxury model is not available in with the light weight frame exterior (e.g., the sport model may be only available with this selection), and because the navigation system may not be available with the cloth seating (e.g., the navigation system may be available only with the leather seating).

The buyer may be displayed an error message indicating the part number entered is invalid (e.g., without informing and/or visually displaying why the part number the buyer entered is invalid). The buyer and/or a seller may manually analyze (e.g., using expensive, trained, and skilled labor) the invalid part number to learn why it is invalid and what portion of the part number has caused multiple degrees of conflicts (e.g., conflicts between (1) frame type and model, and, (2) between seating type and navigation capability). This can be an expensive and slow process, especially when a particular offering (e.g., products and/or services such as an engineering/industrial design, a tiered service plan, a limited stock product, etc.) include multi-levels of inter-relations and/or dependencies.

### SUMMARY

A parameter visualization method and apparatus are disclosed. In one aspect, a method includes processing a selection of a parameter based on an action associated with the parameter, algorithmically calculating compatibility of other parameters based on the selection, and simultaneously displaying at least one allowable parameter (e.g., of the other parameters) in a first visual state and displaying at least one excluded parameter (e.g., of the other parameters) in a second visual state. The parameter and the other parameters may be displayed in a graphical representation (e.g., a two-dimensional and/or a three-dimensional representation), and the graphical representation may be refreshed when another selection is processed based on next action (e.g., the next action may a movement of a pointing device over the graphical representation of the parameter, a data input into an attribute field and/or a physical selection by the pointing device, etc.). The next action may be associated with the at least one allowable parameter.

The other parameters may be displayed in a dropdown list, an input box, and/or a range selector, etc. The range selector may include a minimum value and/or a maximum value. The first visual state may be displayed in a first color and the second visual state may be displayed in a different color (e.g., the different color may be dependent on one or more parameters that disqualified the at least one excluded parameter). The compatibility may be algorithmically calculated and/or may be performed using a function that is based on an engineering constraint and/or an economic constraint. Relationships between various attributes may be formed based on a mutual dependence, a mutual exclusion, a range dependence, a multiple dependence, a multiple exclusion, a mathematical function, an algorithm, and/or a correlation through the engineering constraint and/or the economic constraint.

One or more nested attributes may be visualized based on the selection. A product identifier code may be generated based on the selection and/or the other selection(s). A determination may be made of which parameters and/or attributes are associated with an offering identifier entered by a user. An error data may be generated if an offering (e.g., a product and/or a service) associated with the offering identifier is not available based on an algorithm defining a product and/or a service associated with a configuration incorporating the method.

In another aspect, a method includes determination of attributes associated with a configurator request from a client device, formation of relationships between individual ones of the attributes based on a function associated with a product and/or a service identified in the configurator request, and communicating a configurator to the client based on the relationships established between individual ones of the attributes. Attributes may be extracted from a content module having data associated with a plurality of configurators.

In yet another aspect, a system includes a client device to visualize parameters of a configurator module based on one or more functional relationships between different attributes that constrain the parameters, and a server device to generate the configurator module by allocating at least a subset of available attributes in a content module to a request by the client device for the configurator. The configurator module may include a model generator module to generate a graphical model that structurally displays the parameters. The configurator module may also include an identification generator module to generate a unique identifier data based on the selected parameters. In addition, a reverse configurator module of the configurator module may determine the validity of a configuration and may allocate certain parameters based on an identifier provided in the configurator module.

The configurator module may also include a nesting generator module to visualize a dependent attribute based on a parameter in a general attribute of the configuration module. A relationship manager module of the configurator module may visually represent and/or differentiate between available and/or unavailable parameters in the general attribute and/or the dependent attribute. The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a network view of a server device and a client device communicating a configurator module through a network, according to one embodiment.

FIG. 2 is an exploded view of the server device of FIG. 1 having a content module, according to one embodiment.

FIG. 3 is an exploded view of the client device of FIG. 1, according to one embodiment.

FIG. 4 is a graphical user interface view of the configurator module of FIG. 1, according to one embodiment.

FIG. 5 is a process diagram to determine attributes associated with a configurator request, according to one embodiment.

FIG. 6 is a diagrammatic representation of the configurator module of FIG. 1 and the content module of FIG. 2 associated with a data processing system capable of processing a set of instructions to perform any one or more of the methodologies herein, according to one embodiment.

FIG. 7 is a process diagram to algorithmically calculate compatibility of other parameters based on a selection, according to one embodiment.

FIG. 8 is a process diagram that describes a visualization of operations in FIG. 7, according to one embodiment.

FIG. 9 is a table view of a database in the content module 200 of FIG. 2, according to one embodiment.

Other features of the present embodiments will be apparent from the accompanying drawings and from the detailed description that follows.

### DETAILED DESCRIPTION

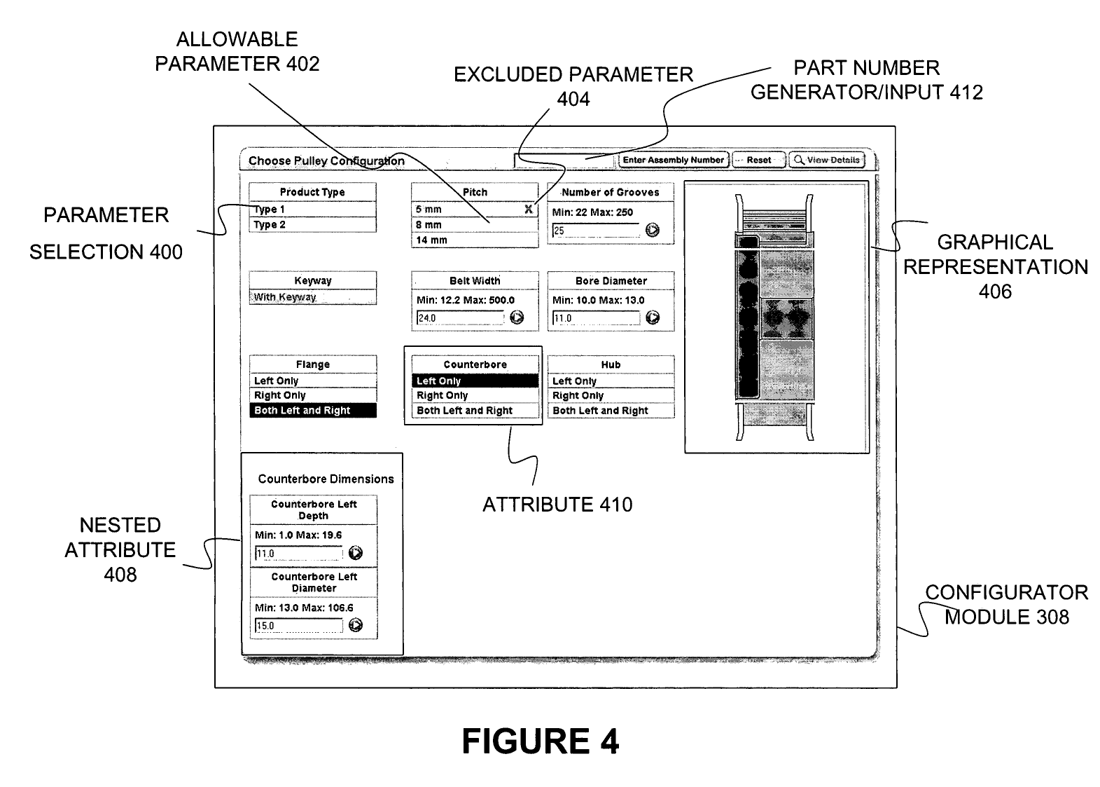

A parameter visualization method and apparatus are disclosed. In the following description, for the purposes of explanation, numerous specific details are set forth in order to provide a thorough understanding of the various embodiments. It will be evident, however to one skilled in the art that the various embodiments may be practiced without these specific details. An example embodiment provides methods and systems to process a selection of a parameter (e.g., a parameter selection 400 of FIG. 4) based on an action (e.g., a mouse click, a mouse over, etc.) associated with the parameter (e.g., ‘Type 1’ in the parameter selection 400 of FIG. 4), algorithmically calculate compatibility of other parameters (e.g., allowable parameters 402 of FIG. 4) based on the selection, and simultaneously display at least one allowable parameter (e.g., the allowable parameters 402 of FIG. 4) in a first visual state (e.g., a black color) and displaying at least one excluded parameter (e.g., excluded parameters 404) in a second visual state (e.g., a grayed-out color).

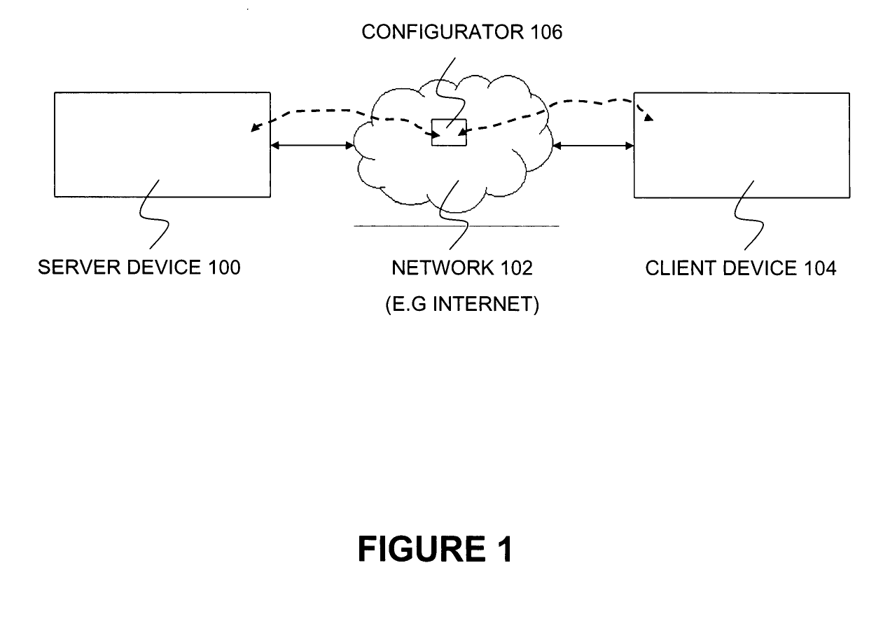

Another example embodiment provides methods and systems for the determination of attributes associated with a configurator 106 request from a client device 104 as illustrated in FIG. 1, formation of relationships between individual ones of the attributes (e.g., an attribute 410 of FIG. 4 that displays multiple choices for parameters) based on a function associated with a product and/or a service identified in the configurator request, and a communication a configurator 106 to the client device 104 (e.g., from a server device 100 of FIG. 1) based on the relationships established between individual ones of the attributes. An attribute may be defined as a variable that is algorithmically dependent on other variables. A parameter may be defined as one or more values acceptable in the attribute. A configurator may be defined as any instrument (e.g, a web based tool, a standalone product, networked software, etc.)) that may aid in a selection of various options available with a product and/or a service.

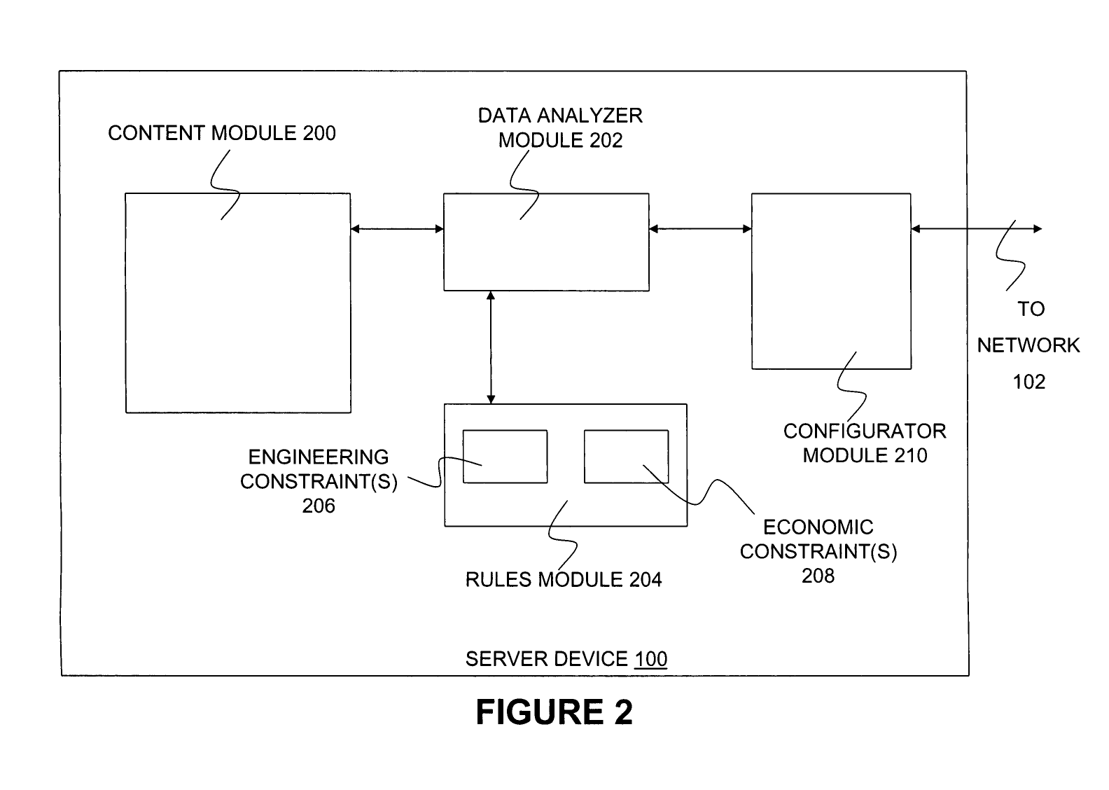

An additional example embodiment provides methods and system for a client device to visualize parameters of a configurator module 210 of FIG. 2 based on one or more functional relationships between different attributes (e.g., the attribute 410 of FIG. 4) that constrain the parameters, and a server device 100 (as illustrated in FIG. 1) to generate the configurator module 210 (e.g., as illustrated in FIG. 2) by allocating at least a subset of available attributes in a content module 200 (e.g. as illustrated in FIG. 2) to a request by the client device 104 (e.g., as illustrated in FIG. 1) for the configurator (e.g., the configurator 106 as illustrated in FIG. 1). It will be appreciated that the various embodiments discussed herein may/may not be the same embodiment, and may be grouped into various other embodiments not explicitly disclosed herein.

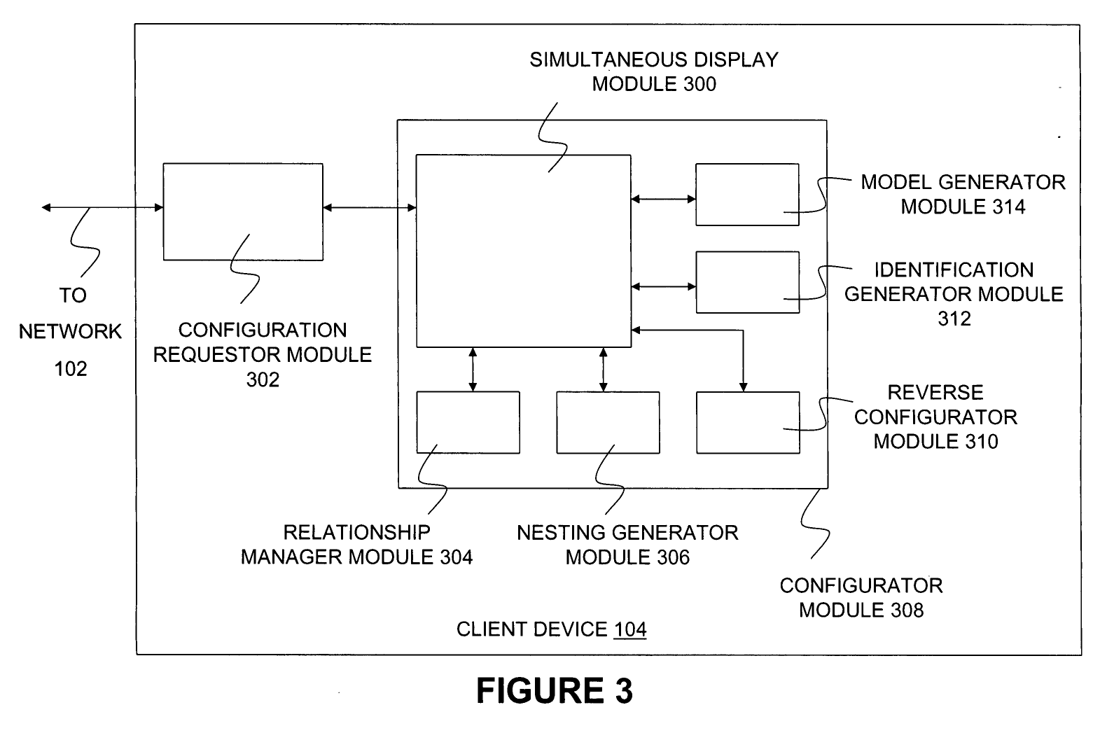

FIG. 1 is a diagram of a server device 100 and a client device 104 communicating a configurator 106 through a network 102 (e.g., an Internet network, a local area network, a wide area network, etc.) according to one embodiment. In one embodiment the server device 100 generates the configurator 106 by allocating at least a subset of available attributes in the content module (e.g., a content module 200 as illustrated in FIG. 2) to a request by the client device 104 for the configurator 106. The configurator 106 may be transmitted through the network 102. Additional details of FIG. 1 are best understood with reference to FIG. 2 and FIG. 3.

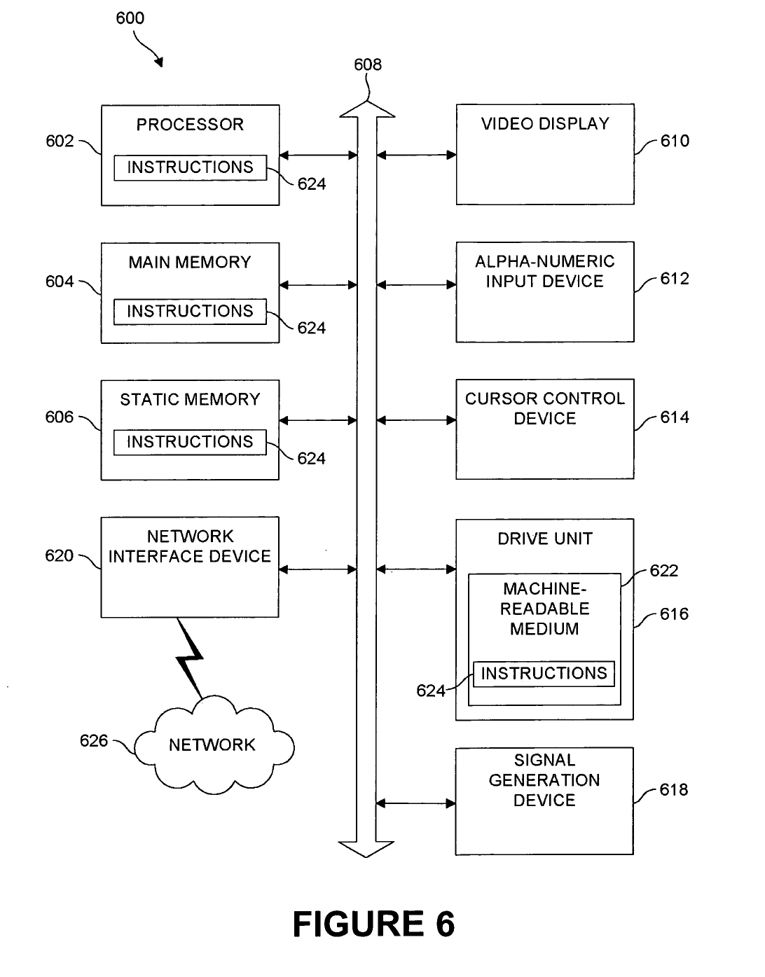

FIG. 2 is a block diagram of the server device 100 of FIG. 1 having a content module 200, a data analyzer module 202, a rules module 204 and a configurator module 210, according to one embodiment. The configurator module 210 may be used to generate a configurator (e.g., the configurator 106 of FIG. 1) based on a configurator request from a client device (e.g., the client device 104 of FIG. 1). The data analyzer module 202 may be used to analyze the configurator request using a processor (e.g., such as a processor 602 of FIG. 6) and to determine what portion of the data in the content module 200 of FIG. 2 is required to create the configurator (e.g., the configurator 106 of FIG. 1). In one embodiment, the data analyzer 202 of FIG. 2 examines a header data of the configuration request and uses a virtualization table to map the header data to specific blocks of data in the content module 200 (e.g., the content module 200 may be a hard disk).

The data analyzer module 202 may also reference the rules module 204 to provide enough data points for the configuration module 210 to generate the configurator 106 of FIG. 1. The rules module 204 may be a collection of algorithms (e.g., functions, mathematical formulas, interrelation-ships, business rules, engineering constraints etc.) that dictate relationships between various attributes in the configurator (e.g., the configurator 106). Specifically, the rules module 204 is illustrated as including both engineering constraint(s) 206 and economic constraint(s) 208. The engineering constraint(s) 206 may be constraints that are determined based on a engineering design limitation, and/or an engineering optimization criteria. The economic constraint(s) 208 may be limitations that are determined based on business, economic, marketing, financial, and/or operational reasons. For example, the engineering constraint(s) 206 may be product design requirements while economic constraint(s) 208 may be based on profit and loss of a business and management priorities (e.g., for example, a business may only which to stock a limited number of configurations because of demand forecasts).

The configurator module 210 may leverage data points (e.g., content associated with various attributes, their interrelationships, and various functions governing limitations of a particular product and/or service associated with the configurator request) collected from the rules module 204 and the data analyzer module 202 to generate the configurator 106 (e.g., as illustrated in FIG. 1) from at least a portion of the content module 200.

In one embodiment, operations may be begin in the server 100 of FIG. 2 when a configurator request is received by the server device 100 from the client device 104 through the network 102 as illustrated in FIG. 1. Specifically the configurator request may be transmitted from the configurator module 210 to the data analyzer module 202 as illustrated in the embodiment of FIG. 2. The data analyzer module 202 may examine the configurator request and may determine attributes associated with the configurator request.

The attributes may then be extracted from the content module 200 having data associated with any number of configurators. The data analyzer module 202 may then form relationship between individual ones of the attributes by communicating with the rules module 204. The rules module 204 may include limitations based on an engineering constraint 206 and/or an economic constraint 208. The relationships between individual ones of the attributes may be based on a function associated with a product and/or a service identified in the configurator request. The configurator generator module 210 may generate the configurator from the data supplied by the data analyzer 202. The configurator may be communicated to the client device 104 through the network 102 as illustrated in FIG. 1.

FIG. 3 is a block diagram of the client device 104 of FIG. 1 having a configuration requestor module 302 and a configurator module 308, according to one embodiment. The configuration requestor module 302 may create a configurator request and the client device 104 may communicate the configurator request to the server device 100 through the network 102 as illustrated in FIG. 1, according to one embodiment. In one embodiment, the client device 104 may permit a user to visualize parameters of the configurator module 308 based on one or more functional relationships between different attributes that constrain the parameters.

The configurator module 308 may be used to process and manage the configurator on the client device 104 of FIG. 3 according to one embodiment. The configurator module 308 may provide a user interface to a user of the client device 104 as illustrated in a graphical user interface view of the configurator module 308 in FIG. 4. The configurator module 308 is illustrated in FIG. 3 as including a simultaneous display module 300, a relationship manager module 304, a nesting generator module 306, a reverse configurator module 310, an identification generator module 312 and a model generator module 314, according to one embodiment. The simultaneous display module 300 may concurrently display at least one allowable parameter in a first visual state (e.g., in black color, in a flashing pattern, etc.) and may display at least one excluded parameter in a second visual state (e.g., in a grayed out color, etc.)

The relationship manager module 304 may visually represent and may differentiate between available and/or unavailable parameters in the general attribute and/or the dependent attribute. The nesting generator module 306 may be used to visualize a dependent attribute based on a parameter in at least one general attribute of the configurator module 308. The reverse configurator module 310 may determine validity of a configuration and may allocate certain parameters based on an identifier provided in the configurator module 308. The identification generator module 312 may generate a unique identifier data based on selected parameters. The model generator module 314 may generate a graphical model that may structurally display the parameters.

FIG. 4 is a graphical user interface view of the configurator module 308 according to one embodiment. Parameter selection 400 shows an action (e.g., movement of a pointing device over a representation of the parameter) associated with an attribute that selects one of the choices (e.g., one of the parameters) associated with the attribute, according to one embodiment. Based on this parameter selection 400, a user can simultaneously visualize the at least one allowable parameter (e.g., the allowable parameter 402) in first visual state (e.g., a black color) and the at least one excluded parameter (e.g., the excluded parameter 404) in a second visual state (grayed out color with an “X” mark). The allowable parameter 402 may be permitted because of an algorithm (e.g., generated by the rules module 204 of the server device 100 of FIG. 2) that may structurally display of the parameters is illustrated in a graphical model (e.g., the graphical model 406) in accordance with a series of business rules, engineering constraints (e.g., the engineering constraint(s) 206 of FIG. 2), and/or economic constraints (e.g., the economic constraint(s) 206 of FIG. 2), in accordance with one embodiment.

Similarly, the excluded parameter 404 may not be allowed because it may not conform (e.g., fit, compute, etc.) within the rules generated by the rules module 204 of the server device 100 of FIG. 2. A dependent attribute (e.g., a nested attribute 408) may be visualized based on a parameter in at least one general attribute (e.g., a general attribute 410) of the configurator module 308 of FIG. 4. The nested attribute 408 may be displayed only when a parameter such as ‘Left Counterbore’ is selected for the attribute 410 as illustrated in FIG. 4. As such, the nested attribute 408 may be dependent upon a value (e.g., the parameter ‘Left Counterbore’) selected in another particular attribute, such as the attribute 410.

Also illustrated in FIG. 4 is a part number generator/input 412. The part number generator/input 412 may be used to automatically create a part number based on the various parameters selected in the configuration module 308 of FIG. 4. Furthermore, the part number generator/input 412 may be used in conjunction with the reverse configurator module 310 as illustrated in FIG. 3 to generate a list of parameters associated with a part number entered in the configurator module 308 of FIG. 4, and/or visually display one or more incompatible (e.g., conflicting) parameters simultaneously on the configurator module 310 by using one or more display techniques (e.g., different colors for incompatible part numbers, colors illustrated as linked with their incompatible counterparts, etc.).

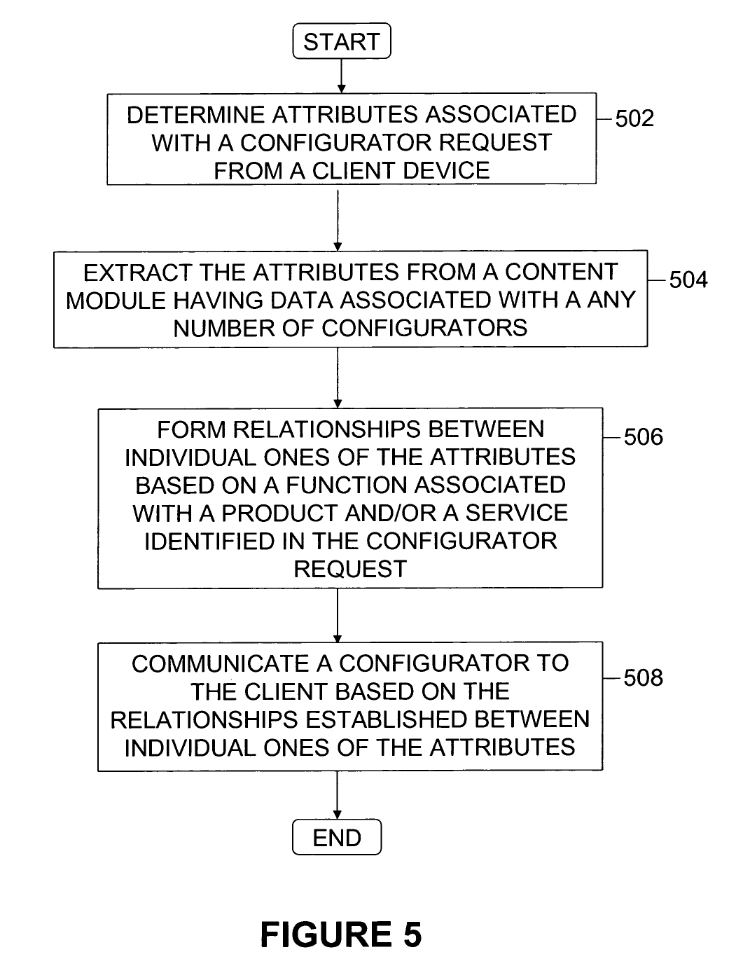

FIG. 5 is a flow chart illustrating a method to determine attributes associated to a configurator request according to at least one embodiment. In operation 502, attributes associated to a configurator request from a client device (e.g., the client device 104 of FIG. 1) may be determined. In operation 504, attributes from a content module (e.g., the content module 200 in FIG. 2) having data associated with any number of configurators may be extracted. In operation 506, relationships between individual ones of the attributes may be formed (e.g., using the data analyzer module 202 of FIG. 2) based on a function (e.g., a function provided by the rules module 204 of FIG. 2) associated with at least one of a product and a service identified in the configurator request. In operation 508, the configurator may be communicated to the client based on the relationships between individual ones of the attributes.

FIG. 6 shows a diagrammatic representation of machine in the example form of a computer system 600 within which a set of instructions, for causing the machine to perform any one or more of the methodologies discussed herein, may be executed. In various embodiments, the machine operates as a standalone device and/or may be connected (e.g., networked) to other machines. In a networked deployment, the machine may operate in the capacity of a server and/or a client machine in server-client network environment, and/or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch and/or bridge, an embedded system and/or any machine capable of executing a set of instructions (sequential and/or otherwise) that specify actions to be taken by that machine. Further, while only a single machine is illustrated, the term “machine” shall also be taken to include any collection of machines that individually and/or jointly execute a set (or multiple sets) of instructions to perform any one and/or more of the methodologies discussed herein.

The example computer system 600 includes a processor 602 (e.g., a central processing unit (CPU) a graphics processing unit (GPU) and/or both), a main memory 604 and a static memory 606, which communicate with each other via a bus 608. The computer system 600 may further include a video display unit 610 (e.g., a liquid crystal display (LCD) and/or a cathode ray tube (CRT)). The computer system 600 also includes an alphanumeric input device 612 (e.g., a keyboard), a cursor control device 614 (e.g., a mouse), a disk drive unit 616, a signal generation device 618 (e.g., a speaker) and a network interface device 620.

The disk drive unit 616 includes a machine-readable medium 622 on which is stored one or more sets of instructions (e.g., software 624) embodying any one or more of the methodologies and/or functions described herein. The software 624 may also reside, completely and/or at least partially, within the main memory 604 and/or within the processor 602 during execution thereof by the computer system 600, the main memory 604 and the processor 602 also constituting machine-readable media.

The software 624 may further be transmitted and/or received over a network 626 via the network interface device 620. While the machine-readable medium 622 is shown in an example embodiment to be a single medium, the term “machine-readable medium” should be taken to include a single medium and/or multiple media (e.g., a centralized and/or distributed database, and/or associated caches and servers) that store the one or more sets of instructions. The term “machine-readable medium” shall also be taken to include any medium that is capable of storing, encoding and/or carrying a set of instructions for execution by the machine and that cause the machine to perform any one or more of the methodologies of the various embodiments. The term “machine-readable medium” shall accordingly be taken to include, but not be limited to, solid-state memories, optical and magnetic media, and carrier wave signals.

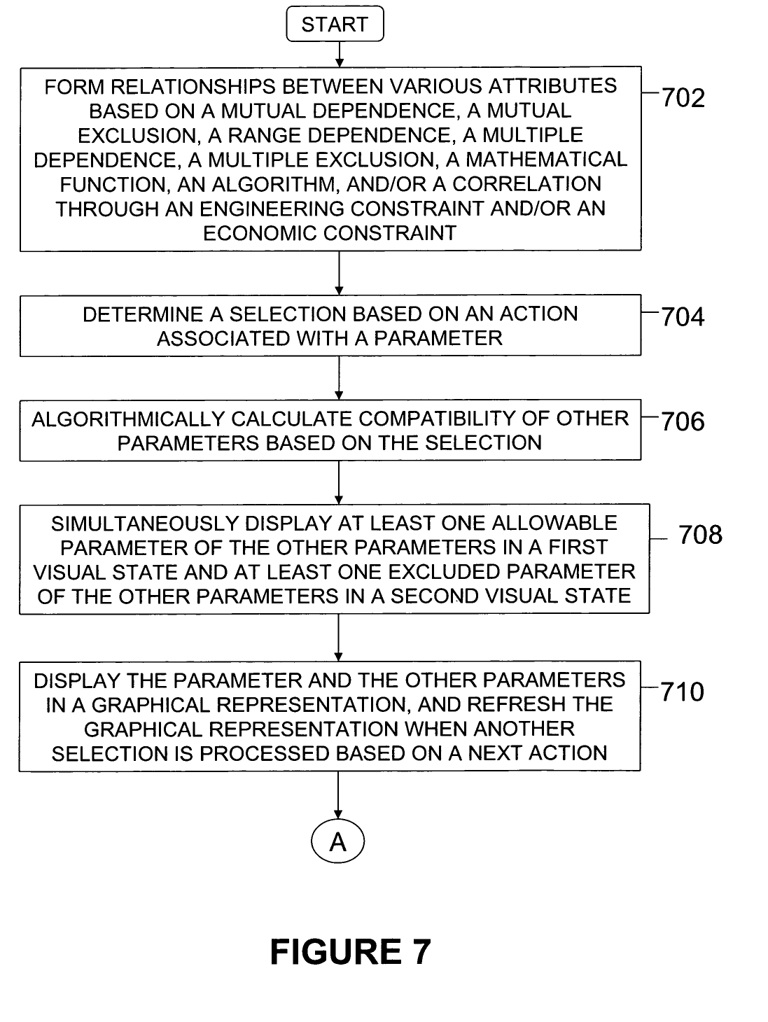

FIG. 7 is a flow chart illustrating a method to algorithmically calculate compatibility of other parameters based on a selection (e.g., a parameter selection) according to at least one embodiment. In operation 702, relationships may be formed between various attributes based on at least one of a mutual dependence, a mutual exclusion, a range dependence, a multiple dependence, a multiple exclusion, a mathematical function, an algorithm, and a correlation through at least one of the engineering constraint (e.g., the engineering constraint 206 in FIG. 2) and the economic constraint (e.g., the economic constraint 208 in FIG. 2).

In operation 704, a selection may be determined based on an action associated to a parameter. In operation 706, the compatibility of other parameters may be calculated algorithmically based on the selection. In operation 708, there may be a simultaneous display of at least one allowable parameter (e.g., the allowable parameter in FIG. 4) of the other parameters in a first visual state (e.g., a black color as illustrated in FIG. 4) and at least one excluded parameter (e.g., the excluded parameter in FIG. 4) of the other parameters in a second visual state (e.g., in a grayed out color with an ‘X’ mark as illustrated in FIG. 4). Next in operation 710, the selection may be displayed in a graphical representation 406 as illustrated in FIG. 4 and the graphical representation may be refreshed when another selection is processed based on a next action associated with the at least one allowable parameter (e.g., the allowable parameter 402 of FIG. 4).

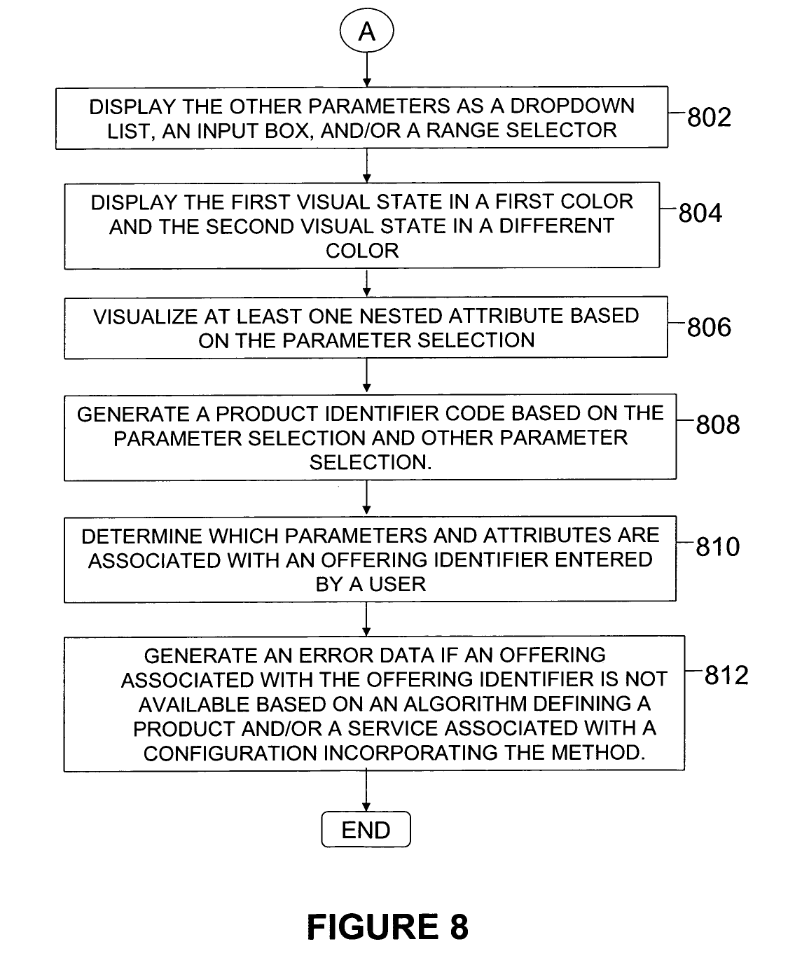

FIG. 8 is a process diagram that describes a visualization of operations in FIG. 7, according to one embodiment. FIG. 8 begins with a ‘circle A’ that connotes a continuation from operation 710 of FIG. 7 (e.g., FIG. 7 concludes with the ‘circle A’). First, in operation 802, the other parameters may be displayed as at least one of a dropdown list, an input box, a range selector and a graphical representation (e.g., as illustrated in various elements in the user interface view of FIG. 4). In operation 804, the first visual state may be displayed in a first color (e.g., a black color as illustrated in FIG. 4) and the second visual state may be displayed in a different color (e.g., a grayed out color with an ‘X’ mark as illustrated in FIG. 4). In operation 806, at least one nested attribute (e.g., the nested attribute in FIG. 4) may be visualized based on the selection.

Next in operation 808, a product identifier code may be generated based on the selection and other selection(s) (e.g., using the reverse configurator module 310 of FIG. 3, the product identifier code may be displayed in the part number generator/input 412 of FIG. 4). In operation 810, parameters and attributes associated with an offering identifier (e.g., associated with a particular product and/or service) entered by a user may be determined. In operation 812, an error data (e.g., an X mark, a strike through display, a simultaneous display, a message) may be generated if an offering associated with the offering identifier is not available based on an algorithm (e.g., generated by the rules module 204 as illustrated in FIG. 2 and provided in a configurator) defining at least one of a product and a service associated with a configuration incorporating the method.

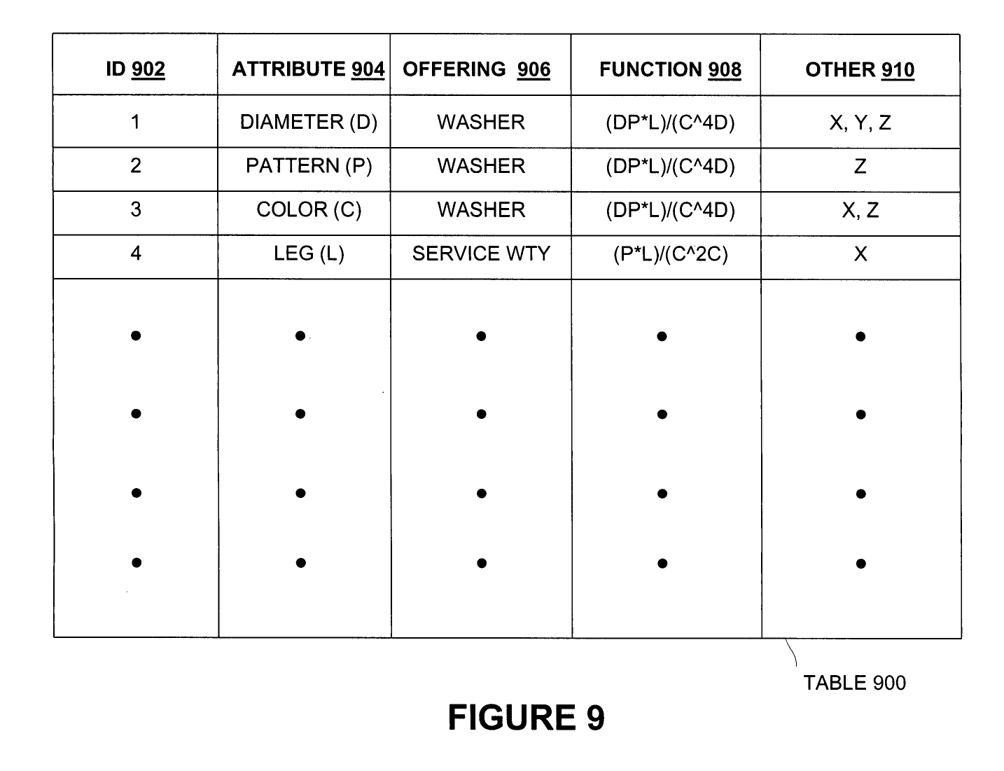

FIG. 9 is a table view of a database (not shown) in the content module 200 of FIG. 2, according to one embodiment. In one embodiment, FIG. 9 may represent a database that contains information and relationships between various attributes and products. An identification (ID) field 902, an attribute field 904, an offering field 906, a function filed 908, and an other field 908 is illustrated in FIG. 9. The identification field may help to index a particular type of product and/or category in the content module 208 (e.g., there may be separate tables for a particular product, product families, and/or subclasses). The attribute field 904 may provide a descriptor of a particular product associated with an attribute in the attribute field 904. For example, in FIG. 9, four different attributes are displayed (e.g., diameter (‘D’), pattern (‘P’), color (‘C’), and leg (‘L’)).

The offering field 906 may discuss a particular end product and/or service that might be identified in a configurator request from the client device 104 to the server device 100 as illustrated in FIG. 1. For example, the offering field 906 in FIG. 9 includes two different types of offerings, one is a product (e.g., washer) and the other is a service (e.g., a service warranty). The function field 908 includes a particular function (e.g., a business rule) incorporated with a particular attribute, and later communicated through the configurator 106 of FIG. 1 from the server device 100 to the client device 104. Two different functions are illustrated in FIG. 9, one associated with the washer offering (e.g., (DP*L)/(Cˆ4D)) and the other associated with the service warranty offering (e.g., (P*L)/(Cˆ2C)). The other field might include index information such as relationships of a particular attribute in the attribute field 904 with other products and/or services.

While certain functions and fields are illustrated in FIG. 9, it will be appreciated that alternate embodiments may include different and/or additional fields. In addition, it will be appreciated that any type of function may be associated with a particular offering 906, and there may be multiple functions co-dependent with other functions in and/or separate from a particular offering 906.

Although the present embodiments has been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium).

For example, the server device 100, the client device 104, the content module 200, the data analyzer module 202, the rules module 204, the configurator module 210, the simultaneous display module 300, the configuration requestor module 302, the relationship module 304, the nesting generator module 306, the configurator module 308, the reverse configurator module 310, the identification generator module 312, and/or the model generator module 314 may be enabled using transistors, logic gates, and electrical circuits (e.g., application specific integrated ASIC circuitry) using a server circuit, a client circuit, a content circuit, a data analyzer circuit, a rules circuit, a configurator circuit, a simultaneous display circuit, a configuration requestor circuit, a relationship circuit, a nesting generator circuit, a configurator circuit, a reverse configurator circuit, a identification generator circuit, and/or a model generator circuit.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method, comprising:
processing a selection of a parameter based on an action associated with the parameter;
algorithmically calculating compatibility of other parameters based on the selection; and
simultaneously displaying at least one allowable parameter of the other parameters in a first visual state and displaying at least one excluded parameter of the other parameters in a second visual state.

2. The method of claim 1 further comprising displaying the parameter and the other parameters in a graphical representation, and refreshing the graphical representation when another selection is processed based on a next action.

3. The method of claim 2 wherein the next action is associated with the at least one allowable parameter, and wherein the action is at least one of a movement of a pointing device over the graphical representation of the parameter, a data input into an attribute field and a physical selection by the pointing device.

4. The method of claim 1 further comprising displaying the other parameters as at least one of a dropdown list, an input box, and a range selector.

5. The method of claim 4 wherein the range selector includes a minimum value and a maximum value.

6. The method of claim 1 further comprising displaying the first visual state in a first color and the second visual state in a different color.

7. The method of claim 6 wherein the different color is dependent on one or more parameters that disqualified the at least one excluded parameter.

8. The method of claim 1 wherein the algorithmically calculating compatibility is performed based on a function that is based on at least one of an engineering constraint and an economic constraint.

9. The method of claim 8 further comprising forming relationships between various attributes based on at least one of a mutual dependence, a mutual exclusion, a range dependence, a multiple dependence, a multiple exclusion, a mathematical function, an algorithm, and a correlation through at least one of the engineering constraint and the economic constraint.

10. The method of claim 1 further comprising visualizing at least one nested attribute based on the selection.

11. The method of claim 1 further comprising generating a product identifier code based on the selection and the other selection.

12. The method of claim 1 further comprising determining which parameters and attributes are associated with an offering identifier entered by a user.

13. The method of claim 12 further comprising generating an error data if an offering associated with the offering identifier is not available based on an algorithm defining at least one of a product and a service associated with a configuration incorporating the method.

14. A method comprising:
determining attributes associated with a configurator request from a client device;
forming relationships between individual ones of the attributes based on a function associated with at least one of a product and a service identified in the configurator request; and
communicating a configurator to the client based on the relationships established between individual ones of the attributes.

15. The method of claim 14 further comprising extracting the attributes from a content module having data associated with a plurality of configurators.

16. A system comprising:
a client device to visualize parameters of a configurator module based on one or more functional relationships between different attributes that constrain the parameters; and
a server device to generate the configurator module by allocating at least a subset of available attributes in a content module to a request by the client device for the configurator.

17. The system of claim 16 further comprising a model generator module of the configurator module to generate a graphical model that structurally displays the parameters.

18. The system of claim 16 further comprising an identification generator module of the configurator module to generate a unique identifier data based on selected parameters; and a reverse configurator module of the configurator module to determine validity of a configuration and allocate certain parameters based on an identifier provided in the configurator module.

19. The system of claim 16 further comprising a nesting generator module of the configurator module to visualize a dependent attribute based on a parameter in at least one general attribute of the configurator module.

20. The system of claim 16 further comprising a relationship manager module of the configurator module to visually represent and differentiate between available and unavailable parameters in the at least one general attribute and the dependent attribute.
